(19) United States
(12) Patent Application Publication
(10) Pub. No.: US 2004/0067094 A1
(43) Pub. Date: Apr. 8, 2004

(54) Trigger construction for ring binder mechanism

(75) Inventor: Chung Nin Ko, Kowloon (HK)

Correspondence Address: SHOEMAKER AND MATTARE, LTD, P.O. BOX 2286, 2001 JEFFERSON DAVIS HIGHWAY, ARLINGTON, VA, 22202-0286, US

(73) Assignee: Hong Kong Stationery Manufacturing Co., Ltd., Kowloon (HK)

(21) Appl. No.: 10/262,658

(22) Filed: Oct. 2, 2002

(51) Int. Cl. B42F 3/02

(52) U.S. Cl. 402/19

(57) ABSTRACT

A ring binder has a releasing trigger whose tips are coated with soft plastic material to provide better feel and to improve the appearance of the ring binder. Triggers are coated by cleaning them with solvent, then dipping them in silicone rubber, curing the silicone rubber, and then top coating with a colored polyvinyl chloride.

### BACKGROUND OF THE INVENTION

This invention relates to a trigger construction for a ring binder mechanism, and to a method of making the trigger.

### SUMMARY OF THE INVENTION

An object of the invention is to improve the feel and enhance the appearance of a trigger for a ring binder mechanism, by coating its tip with a soft, flexible, tactile material.

These and other objects are attained by a trigger construction for a ring binder mechanism, and by a method of making the trigger, as described below.

### BRIEF DESCRIPTION OF THE DRAWINGS

In the accompanying drawings,

FIG. 1 is a perspective view of a ring binder mechanism including a trigger construction embodying the invention;

FIG. 2 is a close-up end view of the trigger alone;

FIG. 3 is a sectional view of the trigger alone, taken on the plane 3-3 in FIG. 2;

FIG. 4 shows the trigger seated in an open fixture;

FIG. 5 shows the fixture closed upon the trigger; and

FIG. 6 illustrates an array of trigger fixtures supported on rotatable shafts within an dipping tank.

### DESCRIPTION OF THE PREFERRED EMBODIMENT

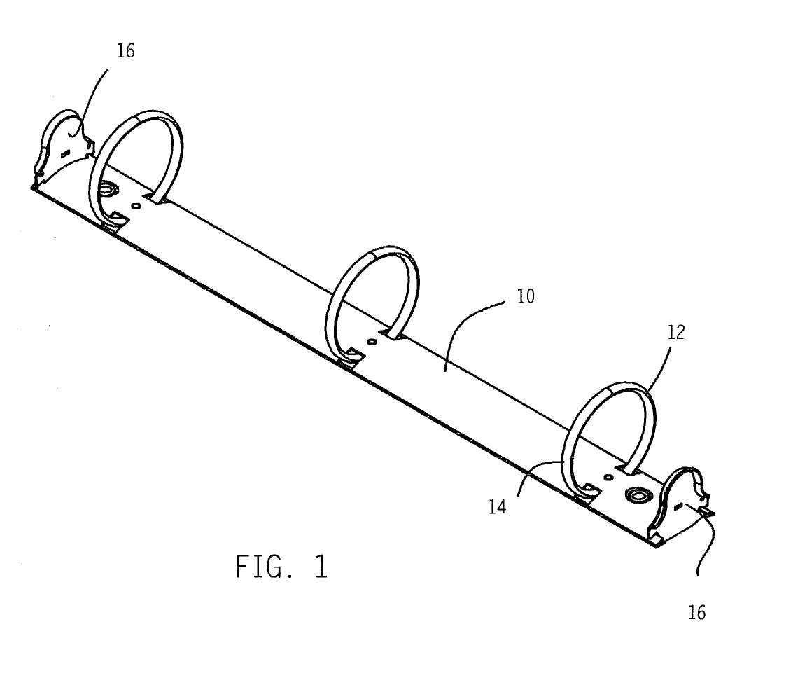

FIG. 1 shows a ring binder mechanism which, like most ring binder mechanisms, includes a casing 10 made of sheet metal, that contains a pair of laterally adjacent rectangular sheet metal leaves (not visible) in lateral compression. Ring segments 12, 14 are affixed to the respective leaves. The mating edges of the leaves are kept aligned by deformations (not shown) made at several points along those edges. The tips have complementary non-planar (e.g., S-shaped) surfaces to maintain tip alignment when the ringers are closed. Triggers 16 at either end of the mechanism provide one way of opening the rings and may also provide a ring-locking function. Each trigger is mounted for pivoting either on the end of the casing or on the ends of the leaves, its lower end being retained between the leaves and the casing by suitable apertures and/or deformations in those parts. The details of the lower portion of the trigger structure are not important to this invention, but for a good example one may refer to U.S. Pat. No. 6,206,601, the description of which is hereby incorporated into this description

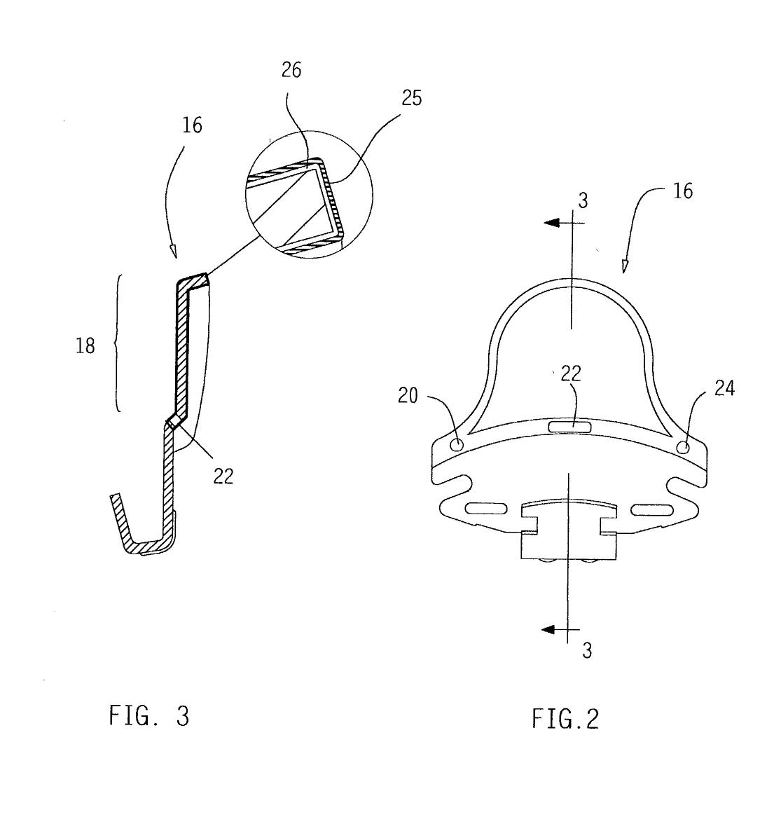

Each trigger 16, one of which is shown in FIGS. 2 and 3, has a flexible coating only on its upper portion 18, to provide improved feel. The holes 20, 22, 24 help anchor the coating, which is preferably applied by the method described in the Example. The coating actually comprises two layers: an inner layer 25 of silicone rubber, and an outer layer 26 of vinyl.

The silicone rubber layer preferably is about 0.4 mm thick, and produces a durometer reading of 4 to 5. The PVC layer preferably is about 0.3 mm thick, and has a durometer of about 6-7, and a coefficient of friction, against a person's finger, of about 0.25 to 0.35, to provide good feel.

The coating method is carried out in a dipping tank 28 shown in FIG. 6, in which an array of trigger-clamping fixtures 30 are supported.

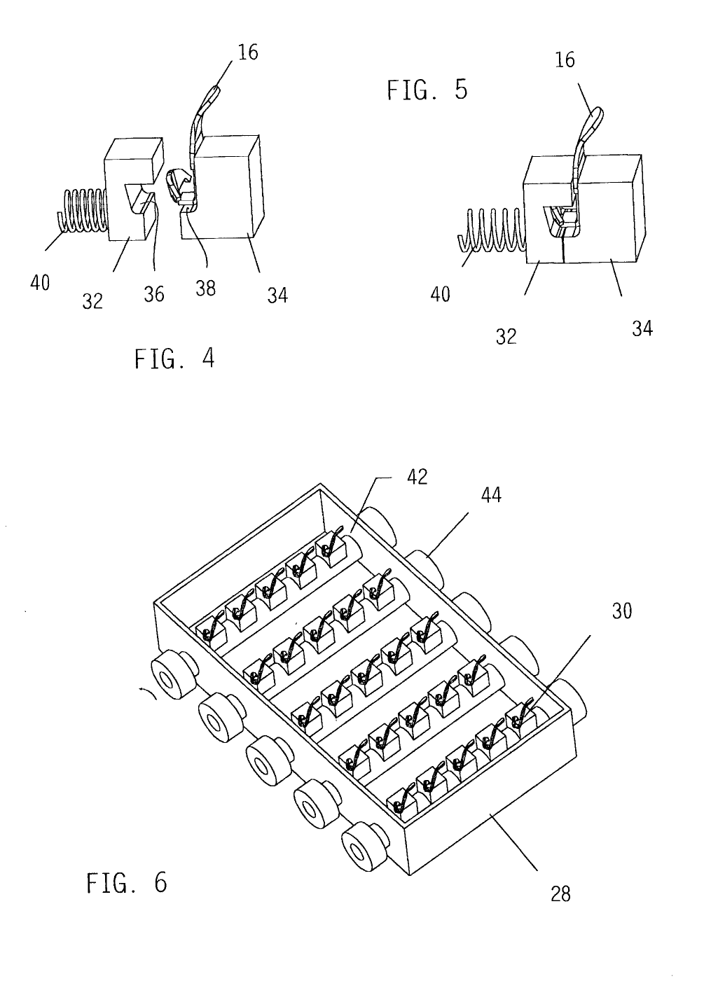

Each fixture (FIG. 4) comprises two halves 32, 34 whose facing surfaces have reliefs 36, 38 which, when the halves are forced closed by a spring 40, define a volume the shape of the lower portion of the trigger. The center portion of the trigger is clamped between the halves, while the tip of the trigger remains exposed.

A linear array of triggers are arranged on each of a series of parallel shafts 42 whose ends are supported by bearings 44 outside the tank. The shafts may be rotated in unison or independently by a mechanism (not shown) to immerse the top portions of the triggers in coating liquid, whose level is maintained below the shafts, at a height such that the fixtures do not contact the coating material.

### EXAMPLE 1

1. Nickel plated metal triggers are washed with cleaning solvent, and then excess solvent is removed. This step is repeated, if necessary, until each trigger's surface is free of grease, dirt and cleaning solvent.

2. The cleaned metal triggers are clamped in respective fixtures, leaving the top portion of each trigger exposed. The fixtures are then inverted by rotating the shafts so that the top portions of the triggers are immersed in transparent and heat resistant silicone rubber. After 15 minutes, the fixture is removed from the tank, and there is a thin layer of underlying coating only on the top part of the triggers.

3. The triggers, still in their fixtures, are then put into a curing oven at a preset temperature of 250° C. for 15 minutes to cure the silicone rubber. After being removed from the oven, the top portions of the triggers are immediately immersed in colored liquid thermal curing PVC for 20 minutes. A preferred PVC liquid comprises 70 parts of PVC emulsion resin, 30 parts of PVC suspension resin, 75 parts of plasticizer, 3 to 5 parts of a stabilizer, and 25 parts of filler.

4. Finally, the triggers are air cooled at ambient conditions to 180° C. or less, and then are removed from the fixture.

Since the invention is subject to modifications and variations, it is intended that the foregoing description and the accompanying drawings shall be interpreted as only illustrative of the invention defined by the following claims.

I claim:

1. A trigger construction for ring binder mechanism, said construction comprising
a metal trigger for opening and closing the ring binder mechanism, said trigger having an upper portion against which one presses to open and close the ring binder and a lower portion which engages said mechanism,
said upper portion being coated with a flexible material.

2. The invention of claim 1, wherein said flexible material is a polymeric material.

3. The invention of claim 1, wherein said flexible material comprises inner and outer layers, of different flexible materials.

4. The invention of claim 3, wherein one of said layers is a silicone rubber.

5. The invention of claim 4, wherein said silicone rubber layer has a thickness of about 0.4 mm and a durometer of about 4-5.

6. The invention of claim 3, wherein one of said layers is a vinyl polymer.

7. The invention of claim 6, wherein said vinyl polymer layer has a thickness of about 0.3 mm and a durometer of about 6-7.

8. The invention of claim 3, wherein the inner layer is a silicone rubber and the outer layer is a vinyl polymer.

9. A method of coating a top portion of a trigger for a ring binder mechanism, said method comprising steps of
cleaning the trigger with a cleaning solvent,
placing the trigger in a fixture, with the top portion of the trigger exposed,
moving the fixture within a tank of transparent and heat resistant silicone rubber to immerse only the top portion of the trigger in the silicone rubber,
curing the silicone rubber in an oven at an elevated temperature to form a flexible first coating, then, without cooling the trigger,
immersing the top portion of the trigger in a thermal-curing liquid polyvinyl chloride and then
removing the trigger from the fixture.

10. The method of claim 9, wherein said elevated temperature is about 250° C.

11. The method of claim 9, wherein said polyvinyl chloride consists essentially of about 70 parts PVC emulsion resin, about 30 parts PVC suspension resin, about 75 parts plasticizer, about 3-5 parts stabilizer, and about 25 parts filler.
